(19) United States
(12) Patent Application Publication
(10) Pub. No.: US 2007/0093277 A1
(43) Pub. Date: Apr. 26, 2007

(54) Updating a static image from an accessory to an electronic device to provide user feedback during interaction with the accessory

(75) Inventors: John Cavacuiti, Burnaby (CA); Matthew Kendall, North Vancouver (CA); Matthew W. Hoag, Burnaby (CA); Jonathan K. Stacey, Burnaby (CA); TC Chang, San Ramon, CA (US); Raymon Hung, Vancouver (CA)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: ACCO Brands Corporation USA LLC, Lincolnshire, IL (US)

(21) Appl. No.: 11/352,194

(22) Filed: Feb. 9, 2006

Related U.S. Application Data
(60) Provisional application No. 60/728,916, filed on Oct. 21, 2005.

(51) Int. Cl. G09G 5/00; H04B 7/00; H04B 1/38

(52) U.S. Cl. 455/566; 455/517

(57) ABSTRACT

An accessory for a portable device can include a number of selectable operational states. In order to convey information about the current operational state to a user, the accessory can be configured to generate a state signal that is directed to the primary device for the accessory. The state signal can include information, such as a static image, about the current operational state that can be displayed on a display device of the primary device. Where a primary device has multiple states than cannot easily be displayed to a user, an accessory can be used to generate a state signal that can be directed to a secondary device in order to display the state information for the primary device using the secondary device.

### CLAIM OF PRIORITY

This application claims priority to U.S. Provisional Patent Application No. 60/728,916, filed Oct. 21, 2005, entitled “Updating a Static Image from an Accessory to an Electronic Device to Provide User Feedback During Interaction with the Accessory,” which is hereby incorporated herein by reference.

### BACKGROUND OF THE INVENTION

As portable consumer electronics, cell phones, and handheld computerized devices become more popular, the need and desire for handheld accessories increases. Many of these accessories are used to modify and/or expand the functionality of a related device, and can serve as an interface between two or more such devices.

For example, portable media players (e.g., MP3 players) are becoming a preferred method of purchasing, carrying, and playing music and other forms of electronic media. Many people would like to be able to play the catalog of songs stored on their media player on other devices, such as a home or car stereo. Since many such stereos do not have input jacks, connectors, or interfaces for receiving the songs and information from these media players, one method of choice involves transmitting the songs using an FM signal that can be received and played by any radio or audio device capable of receiving and playing FM signals. Since different radio markets have different available frequencies, it is desirable to include the ability to change the output frequency of the accessory to ensure that the signal can be broadcast and received without interference from any other FM broadcast or other potential source of interference. It therefore is necessary to indicate to the user the frequency at which the accessory is broadcasting, so that the user knows the appropriate frequency to which to tune the receiving device.

While a display device can be included on the accessory, there are several drawbacks to such an approach. For example, including an analog dial with the approximate frequencies listed thereon, similar to old fashioned radios, can make it difficult for the user to tune the device, particularly when the user is operating a moving vehicle and should be concentrating on the road ahead. It would be possible to include a display screen, such as an LCD screen, on the accessory itself, but the inclusion of such a screen can greatly increase the cost of the accessory, and can require a significant amount of additional power, particularly for a lighted LCD screen necessary to operate the accessory in low light.

There are a number of other applications where the inclusion of a display screen or other indicator would experience similar drawbacks. For example, a user might have a portable video player or video game system for which the user would like to have an accessory allowing the video player to selectively output video in one of several different output modes, such as s-video, RCA, component, or composite video output, as known in the art. The user might want to know the output state of the accessory without having to manipulate a complicated switch or having to concentrate on an accessory screen, and may prefer to have a relatively cheap device that is simple to operate.

In another example, a user might have a portable media player that does not have a view screen, such that the user would like to be able to hook the portable media player up to another device such as a cell phone or PDA to view the song information and/or play mode of the player. In many cases, however, there is no way to directly display the state of one device or accessory on a display mechanism of another device. In another example, the user might wish to attach an FM receiver to a portable media player in order to use the portable media player as a radio, but also would like to view any information (using RDS data, for example) that is broadcast with the signal.

### BRIEF SUMMARY OF THE INVENTION

Systems and methods in accordance with various embodiments of the present invention can allow the present operational state of a device or accessory to be conveyed to a user through an associated device. This can include a device that is physically connected to the accessory, or that is in wireless communication with the accessory, for example.

In one embodiment, a handheld accessory includes an input element providing for the selection of an operational state. A signal corresponding to the selected state can be sent to a primary device for the accessory. The primary device can display information pertaining to the operational state of the accessory using a display screen or other communication mechanism of the primary device. A secondary electronic device can receive a content-based signal from the accessory that is based on content provided by the primary device.

An accessory can include an appropriate state selection mechanism operable to select from one of a plurality of operational states. The accessory also can include a microprocessor for activating or implementing the operational state selected using the state selection mechanism, and can generate a state signal in response thereto. An interface element of the accessory can direct the state signal to the primary device for communication to the user. The state information can be in any appropriate form, such as a static image generated by the microprocessor.

An accessory also can be used to communicate the operational state of a first device using a communication mechanism of a second device. Such an accessory can include interfaces and communication protocols for communicating with each device. A microcontroller can receive state information from the first device, and can generate a state signal in response thereto that can be read by the second device. The state signal then can be directed to the second device for communication to the user, such as through the display of a static image on a display screen of the second device.

Other embodiments will be obvious to one of ordinary skill in the art in light of the description and figures contained herein.

### BRIEF DESCRIPTION OF THE DRAWINGS

Various embodiments in accordance with the present invention will be described with reference to the drawings, in which:

FIG. 1 is a diagram of a system for displaying a broadcasting state of an accessory on a display screen of a connected handheld device in accordance with one embodiment of the present invention;

FIG. 2 is a flowchart showing steps providing for communicating and displaying state information for the system of FIG. 1;

FIG. 3 is a block diagram showing components that can use the method of FIG. 2;

FIG. 4 is a diagram of a printed circuit board and related components that can be used in the devices of FIGS. 1 and 3;

FIG. 5 is a circuit diagram that can be used with the printed circuit board of FIG. 4;

FIG. 6 is a diagram showing a system capable of displaying the state of an accessory on a display device of a connected device in accordance with one embodiment of the present invention;

FIG. 7 is a diagram of an accessory capable of providing output signals in a variety of different video formats and displaying the output video state on the display screen of an attached device in accordance with one embodiment; and

FIG. 8 is a diagram showing an accessory being used between two devices in order to display the state of one device on the display screen of another device in accordance with one embodiment.

### DETAILED DESCRIPTION

Systems and methods in accordance with various embodiments of the present invention can overcome these and other deficiencies in existing devices and accessories by allowing the accessories to display or otherwise communicate state information through an associated device. This can include, for example, an accessory displaying its present state on a display screen of another device, or an accessory displaying the state of a first device using a display screen or other information relay component of a second device. The communication of state information does not have to include a screen for displaying visual data or information, but can include any appropriate device or component capable of transmitting data and information to a user through audio and/or visual approaches.

As used herein, a “state signal” can refer to any signal, generated by an accessory or another device, that exemplifies, or includes information related to, an operational state of an accessory or that other device. Examples of state signals include electronic signals that communicate the frequency and/or amplitude at which an accessory is transmitting content-based information, information about the operational states of an accessory, or information about a secondary electronic device that is operatively coupled to a primary handheld device. A “content-based signal” can refer to a signal that provides content, such as information or media, to an end user, which can include a person or other device. Content-based signals can include music signals, video signals, or the like.

Further, a “primary handheld device” as used herein can refer to any device that can be held in a user's hand, can be carried by the user, or is otherwise portable. Examples of primary handheld devices include MP3 players, cell phones, and PDAs. Such handheld devices are typically sized less than about 1 cubic foot. A “secondary electronic device” as used herein can refer to any suitable electronic device, typically including an audio and/or visual output. A secondary electronic device may or may not be hand-held or portable. Examples of secondary electronic devices include car or home stereos, cell phones, MP3 players, PDAs, and portable computers.

State information in general can include an indication as to the present functional or operational state of the accessory or device. An operational state generally refers to a physical state of the device or accessory. The operational state can be determined by the input(s) the accessory or device receives, and/or the output(s) generated as a result of being in that state. An operational state can be thought of as an functional mode determined by a physical or virtual switch, wherein one of a number of possible functional modes can be selected. An operational state can determine, for example: the type of signal and/or data processing done by the accessory; any functional groups, data modules, software routines, lines of code, functional components, and/or data sources to be used; the way in which a signal or data is processed by the accessory; the external components that can be capable of communicating with the device or accessory while in that state; whether the device or accessory receives and/or transmits information; whether the device is active or passive; or any of a number of other possible states or operational modes of a device or accessory. In one embodiment, the operational state is the frequency at which the accessory transmits a wireless signal. For example, one state might be a broadcast at 88.1 MHz and another state might be a broadcast at 98.7 MHz.

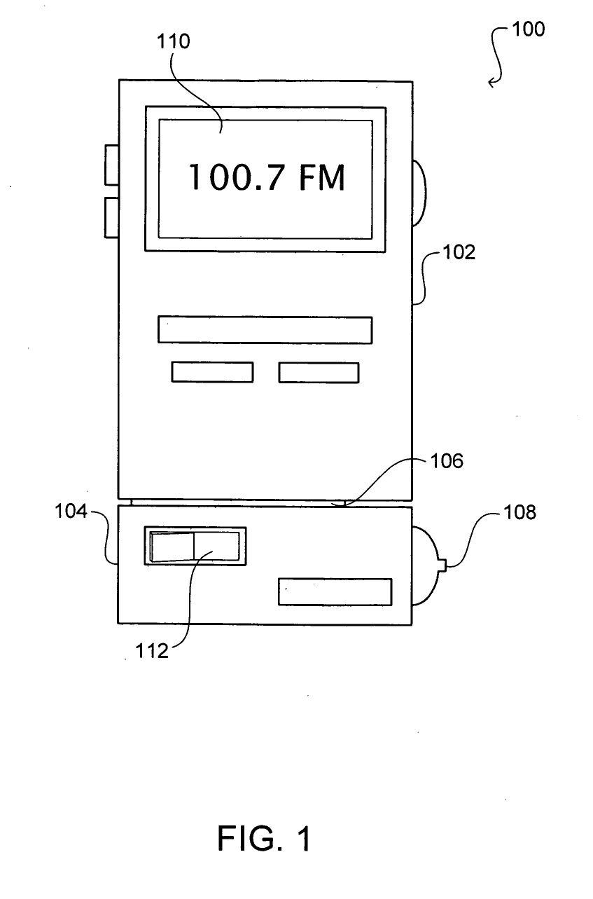

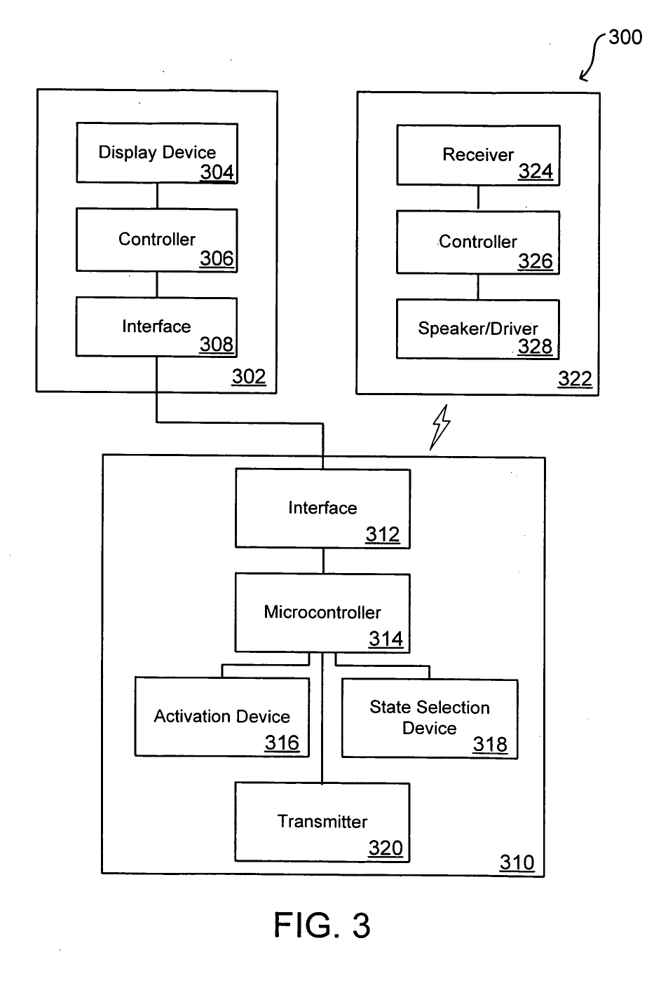

In a first example, FIG. 1 shows an exemplary arrangement 100 wherein an accessory 104 can display state information on a display element 110 of an associated device 102. In this embodiment, the device 102 is a portable media player, such as an audio MP3 player or video player as known in the art. The media player 102 includes a display screen 110, such as an LCD screen, typically used to display information about the media being played, stored, and/or accessed by the player 102. In this example, the accessory 104 connected to the player 102 is an FM transmitting device operable to allow an audio signal being generated by the media player 102 to be broadcast to a receiver (as shown in FIG. 3) using an FM or other appropriate signal.

The accessory 104 can include an activation switch 112 allowing a user to power on the accessory, in order to begin broadcasting audio, streaming from the media player, using the present state of the accessory. The present state of the accessory in this embodiment is the present FM frequency selected to be used to broadcast the signal. A frequency or “state” selection device 108 can allow the user to adjust the frequency at which the accessory broadcasts, in order to avoid interference from local radio stations or other FM-band signals. Each frequency (to the nearest 0.1 MHz across the standard FM band) can correspond to a different operational state of the accessory. The selection device 108 can be a switch that can be moved in a first direction to increase the broadcast frequency and a second direction to decrease the broadcast frequency.

The accessory can include an adapter/connector 106, such as a parallel port, serial port, USB port, firewire port, or other appropriate port or adapter capable of connecting the accessory to the device, while also providing for electronic communication between the device and accessory. The connector 106 can allow the audio signal from the media player to be directed to the adapter, while allowing state information (here specifying the current FM frequency of the accessory) to be directed to the media player. The state information can be in any appropriate format, such as text data or static image information, as known in the art, allowing the device to display information about the accessory, such as manufacturer and/or name information, as well as the present operating frequency (operational state) of the accessory.

In order to transmit the state information to the device, a common communication protocol can be implemented to allow the accessory to communicate with the device. In many instances, this can include obtaining specifications about the device being used, as each device being addressed may have a different communication protocol and/or interface, then building into the accessory the necessary port/adapter type and instruction code for communicating with the device. Approaches to obtaining communication protocol specifics then generating the necessary commands and/or requests are well known in the art and will not be discussed in detail herein. The communication can take the form of a state signal generated by the accessory, wherein the accessory sends information about the operational state to the device for display on a display mechanism of the device. This can include a single signal instance, or can include multiple instances such as requests or instructions in a sequence of communications.

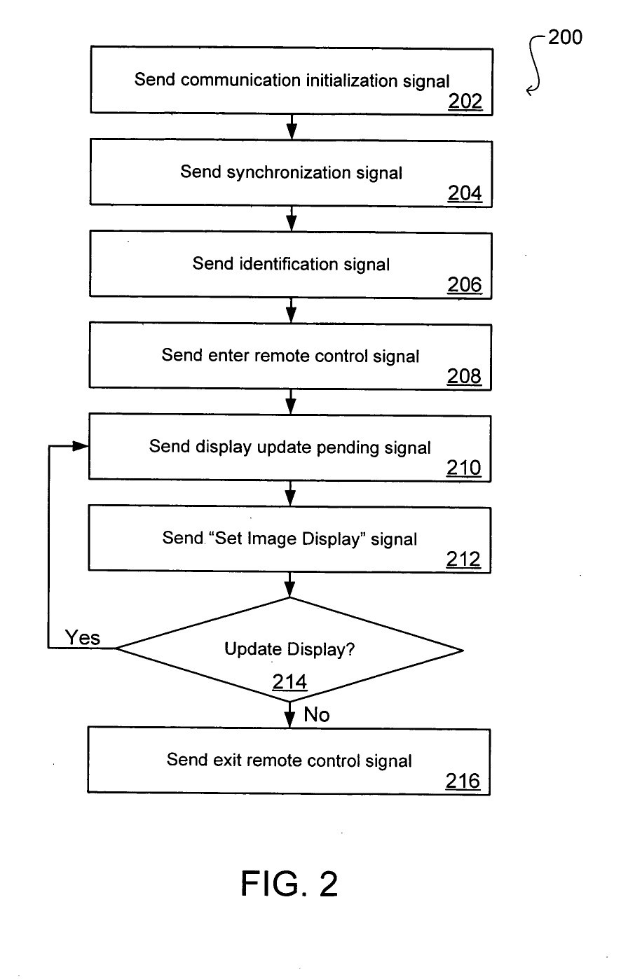

A communication process 200 in accordance with one embodiment is shown in the flowchart of FIG. 2. In this process, the accessory sends an initialization signal to the device through the device connector 202. This can be a simple request using any protocol or language known or used in the art for communicating between electronic devices, including protocols such as SPI, I2C, UART, USB, RS-232 and Parallel Port protocols. The initialization signal can be used to indicate to the device that instructions and/or requests will be forthcoming, as well as to switch or modify operation of the device as necessary. After sending the initialization signal, the accessory can receive an “acknowledge” signal from the device, or the request can timeout after a period of seconds (such as 20 ms, for example). If the request times out, a number of subsequent requests can be sent in order to attempt to initialize the device.

If the accessory receives an acknowledgement signal from the device, the accessory can send a synchronization signal to the device 204. A synchronization signal can be used to ensure that the device is ready to receive instructions/requests from the accessory. Again, the accessory in this embodiment can receive an acknowledgement or timeout. Upon receiving an acknowledgement, the accessory can send an identification signal to the device 206 such that the device can know how to interpret the incoming instructions, and/or can determine whether to grant permission to the accessory. Upon receiving an acknowledgement, the accessory can send a request that the device enter a remote control mode 208. Entering a remote control mode can allow the accessory to temporarily take control of at least a portion of the device functionality, such that the accessory can upload and display state information, here in the form of a static image on the display screen of the device. Upon receiving an acknowledge signal, the accessory can send a signal indicating that there is an update signal pending 210, particularly for the first display for the accessory upon activation, or where the output frequency (state) of the accessory has changed.

Upon receiving an acknowledge signal, the accessory can send a signal to set the image display 212. This signal can include information such as manufacturer name, accessory name, or any other identification information upon first activation, and/or can include frequency or other state information upon any other time for display. Upon receiving an acknowledge signal, the accessory can determine whether the image on the device needs to be updated, such as where the frequency has been changed (or is continuing to be changed) by the user or an automatic tuning device/component, or where information other than frequency (state) information is displayed and it is desired to display frequency information. If there is no further update necessary at the present time, the accessory can send a signal to the device to exit remote control mode 216, whereby the device can display other information (such as song title, etc.) that the device was originally intended to display, either immediately or after some delay. In some embodiments, the accessory can wait a certain amount of time, such as on the order of about five seconds, before sending an exit remote control signal, in order to ensure that a user has time to read the displayed information before the display can be changed by the device. If an update to the display is needed, the accessory can send another update pending signal to the device, and can continue the process. In some embodiments, the process can continue until the accessory receives an acknowledgement of the exit remote control signal, in order to ensure that the device is not left in a remote control state and unable to otherwise function. In other embodiments, the process can be over when the accessory receives an acknowledgement of the exit signal or the process times out at any point. If there is a timeout, the accessory can attempt to restart communications with the device where necessary or desired.

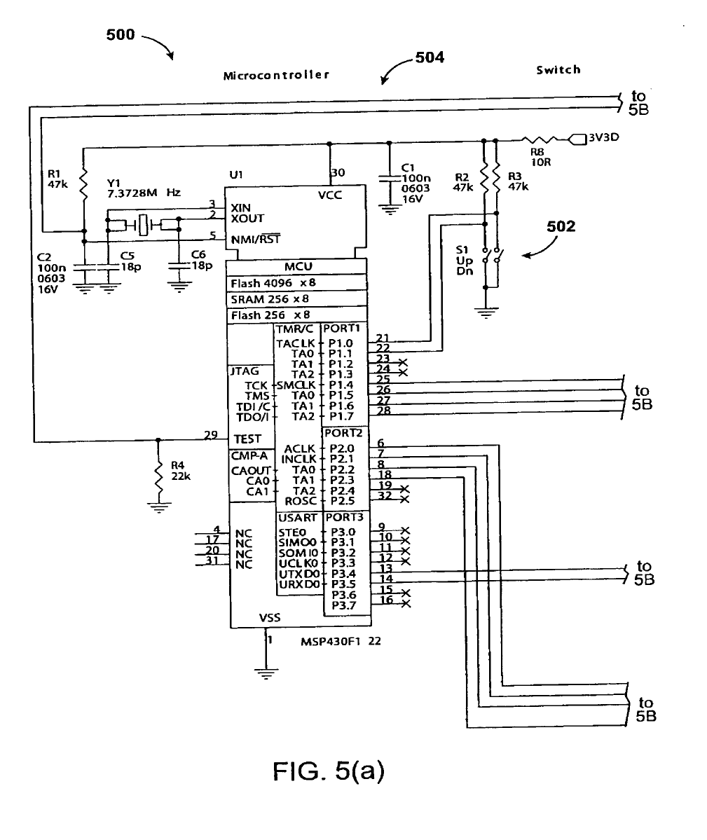

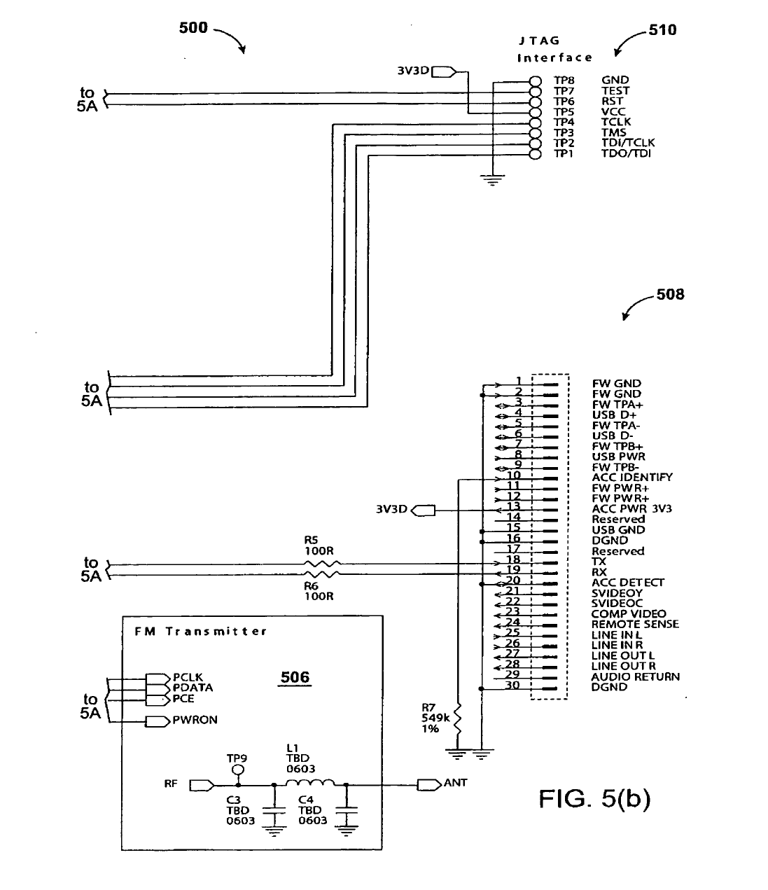

In addition to communicating with a device to receive an audio signal and display state information thereon, the accessory can broadcast the audio signal, here serving as a “content-based” signal based on audio content received from the primary device, using an FM signal to be received by a secondary electronic device, such as an FM receiver or FM radio. An example of such a system 300 is shown in the block diagram of FIG. 3. This system 300 shows a media device 302 including a display 304 for conveying menu and/or other information as known in the art. Display 304 can include a liquid crystal display (LCD), a series of LEDs, or any other visual indicator capable of relaying visual information to a user. Connected with the media device is a multi-state accessory 310 including a transmitter 320. The system also includes an audio player 322 that includes a receiver 324 capable of receiving the signal transmitted by the accessory 310. The primary media device 302 includes a controller 306 (which can include components such as a circuit board, processor, memory, and/or any of a number of other components as known in the art) for controlling the various functions and components of the device, as well as an interface component 308 allowing the device to communicate with other devices and accessories, such as docking stations, cables, and other accessories. The accessory 310 can contain a second interface 312 for communicating through the first interface 308 of the primary device 302. The accessory also can contain a microcontroller 314 for controlling the various functions and components of the accessory. The microcontroller 314 can be in direct communication with an activation device 316, such as a switch that allows a user to activate the accessory 310. The microcontroller 314 also can be electrically connected with a state selection device 318, such as a knob, slider, push button, wheel, or other input mechanism operable to allow a user to select between a number of different operational states of the accessory 310, in this embodiment allowing the user to select the operational frequency of the accessory. The accessory also can include a transmitter 320 operable to transmit the audio signal received from the primary device 302 using a frequency as set by a user using the state selection device 318. The transmitter can include an antenna (shown in FIG. 5) or any other component useful in transmitting the audio signal.

The signal broadcast by the accessory transmitter 320 can be received by a receiver 324 of the secondary device 322. The transmitter 320 and/or receiver 324 can include antennas or any other elements necessary to receive and/or transmit a signal using the selected carrier type (e.g., an FM frequency signal). The receiver 324 can direct the signal to a controller 326 operable to decode the audio signal from the receiver 324, where necessary, and direct the audio signal to the appropriate speaker(s) or speaker driver 328, in order to play the received audio signal. This can include a car stereo operable to transmit a signal to a set of car speakers, a home theater unit operable to decode and transmit the signal to the appropriate surround speakers, or a portable stereo including speakers hardwired to the controller and incorporated in the secondary device. The secondary device 322 also can be configured to rebroadcast the decoded audio signal to remote speakers or speaker systems, such as by using a wireless connection as known in the art. In another embodiment, the receiver may be separate from the device used to play the audio, or may be used to capture and store the audio for later retrieval.

Information about the audio content included in the FM signal can be included as known in the art, such as by using radio data system (RDS) technology. RDS is one exemplary standard for sending small amounts of digital information using conventional FM radio signals. The RDS system standardizes several types of information that can be transmitted in various fields, include information such as station identification, a radio text field, and any of a variety of other fields as known in the art. Any of these appropriate fields can be used to send description information for songs, artists, or any other appropriate information. This information can be broadcast by the accessory and received by the secondary device, and can be displayed by a display device of the secondary device. In one embodiment, the accessory can be configured to input state information into at least one of these RDS fields, allowing the accessory to easily transmit information to the receiver in a way that is already readable, and capable of being displayed by, the receiver.

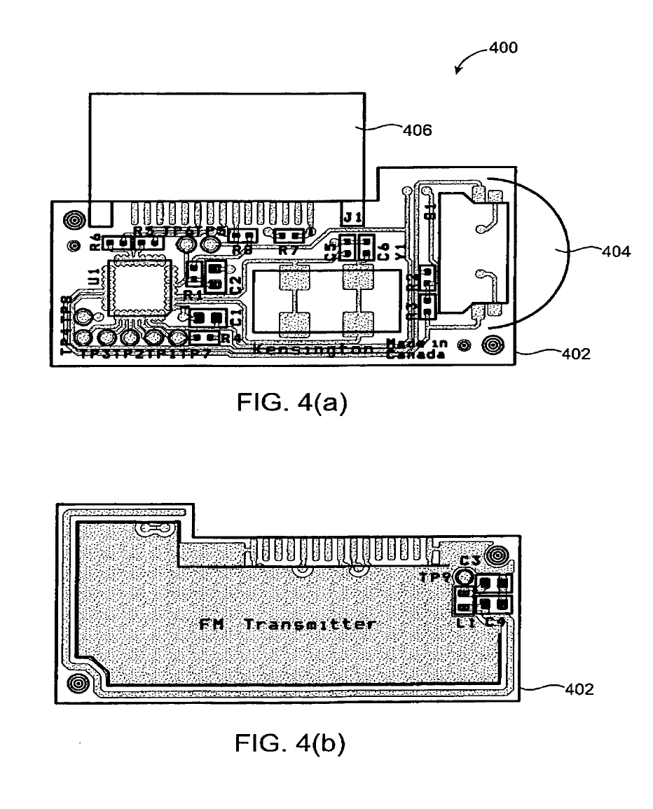

The accessory of FIG. 3 can include the functional components on a printed circuit board (PCB) inside a housing, such as a substantially rectangular plastic housing. An exemplary layout 400 for such a circuit board 402 and the associated components is shown in the example of FIGS. 4(a) and 4(b). FIG. 4(a) shows a first side of the PCB, where can be seen a connector 406 for connecting the circuit board to an interface of the primary device. The connector 406 can include pins and/or printed electrical lines operable to allow the components of the PCB to communicate with the components of the primary device. The PCB also is shown to include a switch 404 that allows the user to change the operating frequency of the accessory through manipulation of the switch as known in the art. FIG. 4(b) shows an opposite side of the PCB 402, which can include space for the FM transmitter and any other appropriate components.

The PCB can include a circuit thereon that is similar to the circuit 500 shown in FIG. 5. As can be seen, this circuit includes a microprocessor 502 connected through a first port to the state selection switch 502, which allows the user to determine the operating frequency of the FM transmitter 506. The first port also allows the microprocessor 502 in this embodiment to communicate with a JTAG interface 510. A JTAG interface is an interface complying with the Joint Test Action Group IEEE 1149.1 standard for a test access port, primarily used for testing integrated circuits, but also useful for debugging embedded systems. A JTAG interface can allow a programmer to access an on-chip debug circuit that is integrated into the CPU, processing element, or controller via a JTAG interface in order to debug the software of an embedded system. A JTAG interface as known in the art typically includes a four or five pin interface designed so that multiple chips can be tested using a single JTAG interface.

A second port of the microprocessor 504 allows the microprocessor to communicate with the FM transmitter 506. As shown in this diagram, this transmitter 506 includes four pins: a programming clock (PCLK) pin, a programming data (PDATA) pin, a programming counter enable (PCE), and a power supply (PWRON) pin. These pins allow the microprocessor to send instructions relating to the operating frequency of the transmitter 506, as well as to send the audio signal, received from the primary device, to be broadcast by the transmitter. The transmitter also is shown to include an antenna device (ANT), which can be used where necessary to broadcast the FM signal.

A third port of the microprocessor 504 can allow the microprocessor to communicate with the primary device through an appropriate interface 508, here shown to be an Omni interface operable to connect and communicate with various media players. As shown in the diagram, various voltage and ground signals can be applied to the interface 508, but the primary signals between the microprocessor and the interface are a transmit (TX) and a receive (RX) signal, allowing information to be sent to and from the primary device. These communication lines can be used to transmit requests and/or instructions similar to those described with respect to the process of FIG. 2.

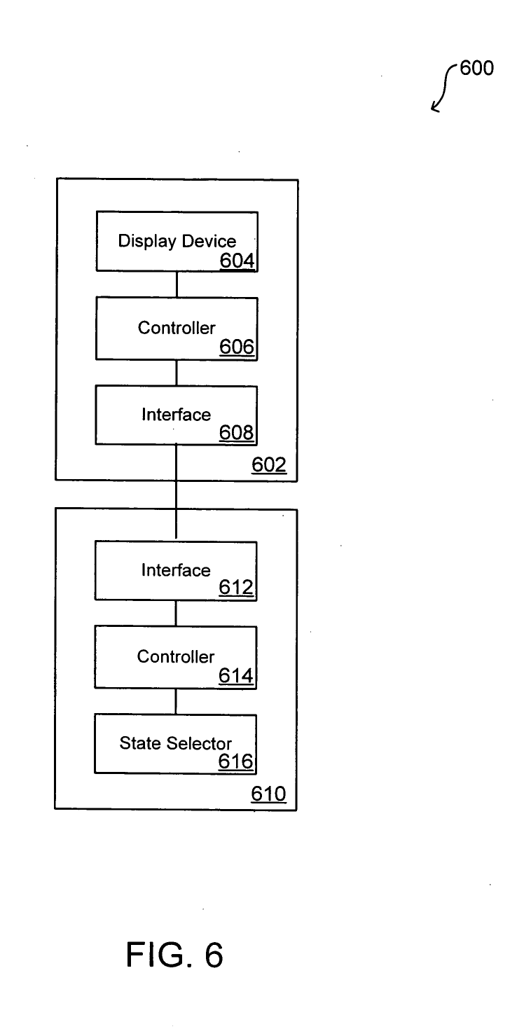

As discussed above, the use of an FM transmitter accessory with a handheld media player is only one example of the many applications of embodiments in accordance with the present invention. There can be many other devices and accessories, which can include a number of basic components such as those shown in the configuration 600 of FIG. 6. This configuration shows a basic handheld or portable device 602, along with a basic accessory 610 connected with, or at least in communication with, the portable device. The accessory includes a state selector 616, which can include a state selection device, state selection logic, state selection code, or any other appropriate approach, mechanism, device, or component for selecting or altering a functional or operational state of the accessory, through hardware, software, or a combination thereof. Examples of a state selector can include, for example, a physical switch, virtual switch, adjustment knob, slider, push button, touch screen, joystick, mouse, track ball, software algorithm, or logic element. The state selector 616 can be connected and/or in communication with a controller, which can include a processor, circuit, electronic device, logic element, or any other appropriate element or component operable to manipulate the state of the accessory by implementing, facilitating, requesting, or directing a change in state of the accessory 610 as indicated through manipulation or direction of the state selector 616. The accessory also can include an interface 612, which can include anything from complex logic elements to a simple electrical connector, as known in the art, which allows the accessory 610 to communicate with the primary device 602.

As shown, the primary device 602 also can include a number of basic components. For example, this device includes an interface 608 that allows the device to communicate with the interface 612 of the accessory, as well as any of a number of other interfaces adapted to communicate with the device. The device also includes a controller 606, which can include a control circuit, microprocessor, memory element(s), functional devices, and any of a number of other elements operable to control at least some of the functionality of the device 602. The device also can include a display device that provides various functionality for the device, as well as allowing the accessory to display state information to a user of the device. As discussed above, this transfer of information to the user can take any of a number of visual and/or audible forms, such as the transmission of a static image via a display screen or projection element, as well as the emission of an audible signal through a speaker, chime, or other audio element. Any element capable to indicating the state of the accessory to a user can be used in accordance with the various embodiments.

For example, an accessory having four different operational states might send a static image to the primary device that displays the current operational state of the accessory to the user by displaying that image on a screen. In another embodiment, the primary device might play a different tone for each of the four states, indicating the current operational state of the accessory to the user. In yet another embodiment, the device might “speak” the state of the device to the user, such as by playing a recorded audio message or using voice generation technology to indicate the present state of the accessory to the user.

The accessory also may be capable of sending a request for feedback, or capable of receiving feedback, from a device. For example, after updating the state information displayed on the device, the accessory might send a request such as a “state ok?” request to the device. If the device is receiving a signal corresponding to that state, for example, the device can inform the accessory whether or not the signal is being properly received and utilized. In the event that the signal is not being properly received, the accessory can be allowed to automatically change state in an attempt to generate an acceptable signal for the device, or can be adapted to display a message to the user through the display on the screen of the device, if possible, that the user should attempt to change the state of the accessory. A number of other reasons for feedback from the device in such an embodiment would be obvious to one of ordinary skill in the art in light of the discussion herein and, as such, will not be discussed herein in detail.

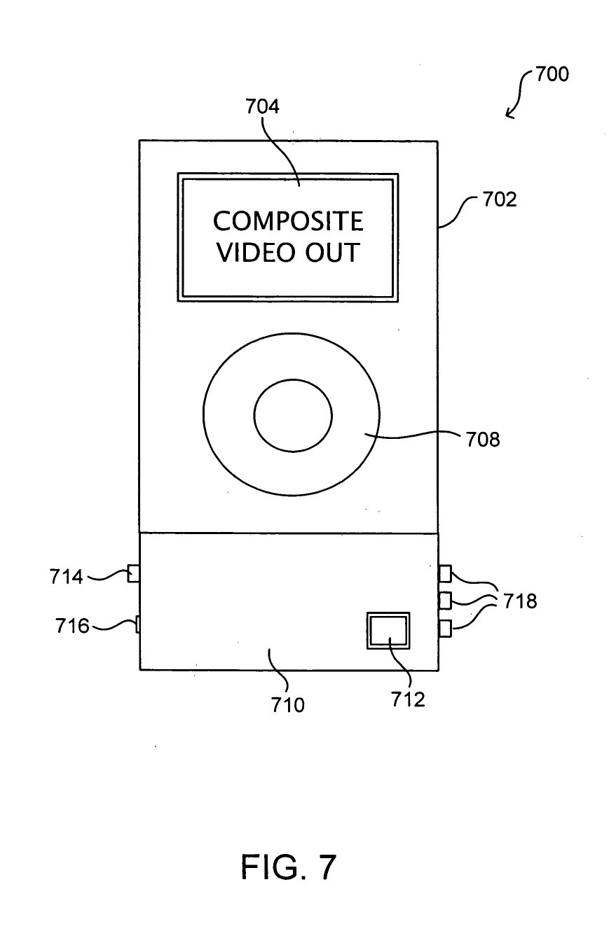

FIG. 7 shows another example of a configuration 700 utilizing the basic components of FIG. 6. In this configuration, the device is a portable media player 702 capable of playing video or displaying images or other digital information on a video display 704, in this embodiment an LCD screen. The media player has at least one selection element 708 allowing a user to control the video or image content displayed on the video screen. The media player also is operable to output the video content as a video signal through an interface on the bottom of the device.

Connected to the media player via the interface is a video accessory 710. This accessory can convert the video signal output by the media player to any of a number of different video modes. For example, this accessory can include output ports for RCA 714, s-video 716, and component 718 video modes, having the appropriate hardware and signal converters for each mode as known in the art. A push button 712 on the front of the accessory 710 can act as a state selection switch, allowing a user to cycle through the various output video modes in order to provide the proper output signal for a secondary device, attached or otherwise in communication with the video accessory 710. Other video modes are possible, and approaches for converting between video signals are well known in the art and will not be discussed herein in detail. Each time the user presses the state selection switch 712, the video signal can be directed to a different one of the video output ports. Further, a static image can be directed from the accessory 710 to the primary device 702, whereby an image indicating the selected mode/state can be displayed on the video screen 704 of the video player 702. This can include a name or description of the mode, for example, or can simply be a character or other simple indicator of the present state of the accessory.

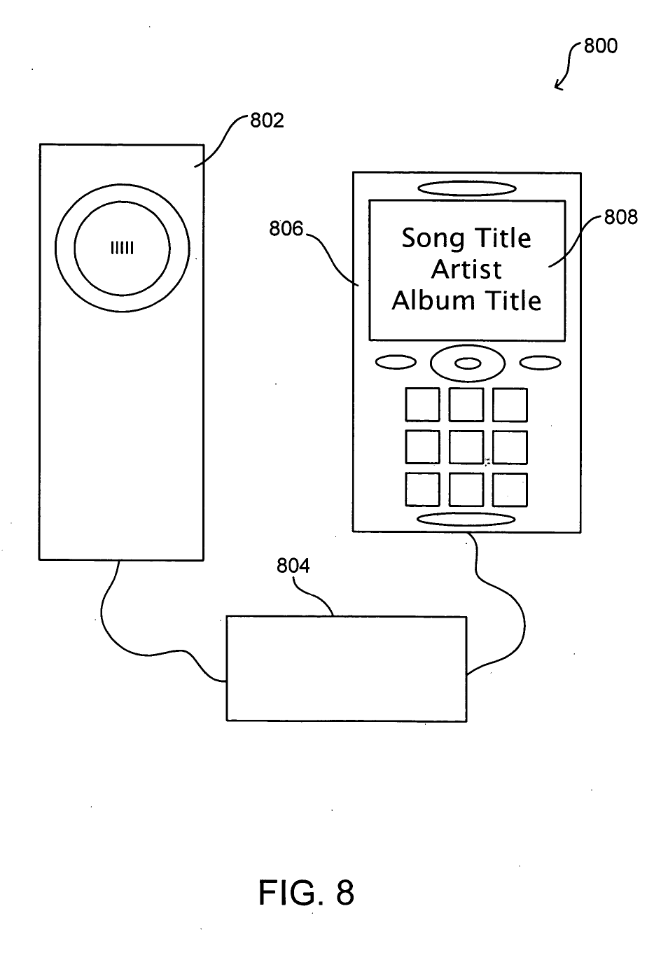

An example in accordance with another embodiment will be described with respect to the configuration 800 of FIG. 8. In this embodiment, the accessory 804 does not include a plurality of possible states as in previously described accessories, but instead allows the state of a primary handheld device 802 to be displayed using a display screen or other information transmission element of a secondary electronic device 806. The primary device 802 in this example is a personal media player that does not include a video screen or other device for transmitting information to a user. The primary device does include a primary output, such as a headphone jack, for transmitting a media signal to a user, such as may contain music stored on the primary device.

This exemplary media player 802 does not include any way to relay state information to a user. The media player 802 can have a number of possible states, such as different playback modes, song ordering options, playlist support, and other states as known in the art. The lack of a display screen can make it difficult for a user to determine the current operational state of the device without separately testing each mode. Further, the songs or other media files stored on the media player can have information associated therewith, such as artist and song information, which cannot otherwise be displayed to the user.

In order to provide such state information to a user, an accessory 804 can be used that can receive and/or interpret this information. The accessory may or may not be able to change the state of the primary device, depending upon the embodiment and/or application, but can be able to at least receive the state information from the primary device through a connection with the primary device.

Once the accessory has received state information from the primary handheld device 802, the accessory 804 can transmit this information utilizing an appropriate connection (hardwire or wireless) with a secondary device 806. In this embodiment, the secondary electronic device is a device such as a cell phone or PDA having a view screen that is capable of displaying visual information to a user. The state information for the primary handheld device 802 then can be displayed on the display screen of the secondary device, allowing the user to quickly and easily determine the present operational state of the primary handheld device 802.

In general, connecting two devices to allow video from one device to be displayed using another device is known. For example, a video player can display video images using a television or video monitor. There are at least two significant differences that can be pointed out between this video playing system and embodiments in accordance with the present invention. First, the video player is designed to communicate with, and play the video information on, the television set. In the example of FIG. 8, the media player is not designed to provide state information using a cell phone, as there is no way to connect the two devices, and neither device includes the protocol or communication information necessary to allow the two devices to communicate.

Second, a video player does not display state information using the television or video monitor, as a video player only displays video information on a television when the video player is in the appropriate state. If the video player is not in the appropriate state, such as RCA video out, then no information will be displayed on the television. If the video player does not itself have a display, there will be no way to determine the current state when the player is in any other state. By comparison, using an accessory in accordance with one embodiment of the present invention allows state information of a primary handheld device to be displayed using a display mechanism of a secondary electronic device regardless of the state of the primary device (except for maybe an “off” state). Previous systems did not include this functionality.

Systems and methods in accordance with other embodiments also can allow state information to be displayed or otherwise communicated to a user using a mechanism contained in another device. In one example, an accessory can include an FM receiver that is adapted to receive FM transmissions and direct the corresponding audio as a signal capable of being played by a media player device in communication with the accessory. As discussed above, the FM signal can include RDS or other information that can be translated by the accessory and uploaded to the media player for display on a display screen of the media player.

In another embodiment, a cell phone or PDA can act as the primary device, wherein the phone or PDA includes personal contact information, as well as the ability to play music or other media. An accessory can be used to connect the phone/PDA to a personal computer, using either a hardwire or wireless connection as known in the art, when the user wishes to transfer the contact information, and to connect to a receiver when the user wants to play music. The output mode of the primary device can correspond to any of a number of different states, and the accessory can be configured to display the state information using a personal computer in one embodiment, regardless of whether the output mode corresponds to the personal computer. For example, the computer might display a panel corresponding to the primary device, which includes state and other information about the primary device whether or not the primary device is in a state that corresponds to the computer. For instance, the panel could state that a cell phone is in a “music” state, and can provide information about the music being played on a separate receiver. In another embodiment, the accessory can be configured to use a display of the computer when the cell phone is in a “contact transfer” state, and can be configured to use a display of the receiver when the cell phone is in a music playing state. Where the accessory is in communication with a number of secondary devices, the accessory can choose a single secondary device to use for displaying information, or can choose all secondary devices, the active secondary device, or any other appropriate selection approach for displaying state information on at least one of the secondary devices.

Functionality of various embodiments can be implemented through any appropriate combination of hardware and software as known in the art. Software and control logic can be created by one of ordinary skill in the art using any suitable programming language, such as C or C++. Control logic can be stored in an information storage medium, contained internally or externally to the accessory and/or device, as a plurality of instructions or program code for directing an information or data processing device to perform steps, or sets of steps, which can indicate and/or be a result of the operational state of the accessory and/or device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

What is claimed is:

1. A system for updating operational state information to a handheld device, comprising:
a hand-held accessory including an input element and an output element and having multiple operational states, the input element operable to provide for selection of one of the multiple operational states and cause a state signal to be generated in response thereto;
a primary handheld device including a display screen operable to receive the state signal from the hand-held accessory and display information pertaining to the selected one of the multiple operational states; and
a secondary electronic device operable to receive a content-based signal from the output element of the hand-held accessory.

2. A system according to claim 1, wherein:
the hand-held accessory includes a microprocessor operable to generate the state signal in response to the selection of the selected one of the multiple operational states and direct the state signal to the primary handheld device.

3. A system according to claim 2, wherein:
the state signal includes static image information corresponding to the selected operational state, the primary handheld device being further operable to display the static image.

4. A system according to claim 2, wherein:
the microprocessor is further operable to generate a subsequent state signal in response to a subsequent selection of a subsequent one of the multiple operational states and direct the subsequent state signal to primary handheld device for display.

5. A system according to claim 1, wherein:
the content-based signal includes content received by the hand-held accessory from the primary handheld device.

6. A system according to claim 1, wherein:
the secondary electronic device is further operable to transmit the content in the content-based signal to a user.

7. A multi-state accessory for use with a primary handheld device including a display mechanism, comprising:
a state selection device operable to select from one of a plurality of operational states for the accessory;
a microcontroller in communication with the state selection device and operational to activate the operational state selected by the state selection device, the microcontroller being operable to generate a state signal in response to the activation of the operational state and further operable to generate a content-based output signal to be received by a secondary electronic device; and
an interface element in electrical communication with the microcontroller, the interface element configured to provide for communication with the primary handheld device, the interface operable to direct the state signal to the primary handheld device whereby the primary handheld device can display state information in the state signal on the display mechanism of the primary handheld device.

8. An accessory according to claim 7, further comprising:
an activation element operable to activate the accessory.

9. An accessory according to claim 7, wherein:
the type of content-based output signal is dependent upon the selected one of the plurality of operational states.

10. An accessory according to claim 7, wherein:
the accessory receives an input signal from the primary handheld device containing content that is used to generate the content-based output signal to be received by the secondary electronic device.

11. A method for updating operational state information to a portable device, comprising:
selecting one of a plurality of operational states of a multi-state accessory;
generating a state signal in response to the selecting step;
directing the state signal to the portable device, whereby the portable device can display information about the selected operational state on a display mechanism of the portable device; and
generating a content-based output signal in response to the selection of one of the plurality of operational states, the content-based output signal not being used by the portable device.

12. A method according to claim 11, wherein:
the type of content-based output signal is dependent upon the selected one of the plurality of operational states.

13. A method according to claim 11, further comprising:
receiving an input signal from the device containing content that is used to generate the content-based output signal.

14. A method according to claim 11, further comprising:
generating a static image corresponding to the selected one of the plurality of operational states and including the static image in the state signal for display by the portable device.

15. An accessory for displaying the operational state of a first device using a display mechanism of a second device, comprising:
a first interface operable to connect and communicate with the first device;
a microcontroller in electrical communication with the first interface and operable to receive state information from the first device, the state information including information about an operational state of the first device, the microcontroller being further operable to generate a state signal in response thereto; and
a second interface operable to connect and communicate with the second device, the second interface operable to direct the state signal from the microprocessor to the second device whereby the second device can display information about the operational state on the display mechanism of the second device.

16. An accessory according to claim 15, wherein:
the microprocessor is operable to communicate with the first device using a first communication protocol and communicate with the second device using a second communication protocol.

17. An accessory according to claim 15, wherein:
the state signal includes static image information corresponding to the selected operational state to be displayed by the second device.

18. An FM transmitter for use with a portable media device, comprising:
a frequency tuner operable to select from one of a plurality of operational frequencies;
a transmitter in electrical communication with the frequency tuner and operable to broadcast a signal at the selected operational frequency;
a microcontroller in communication with the frequency tuner and operable to generate a state signal in response the selection of the selected operational frequency; and
an interface element in electrical communication with the microcontroller, the interface element configured to provide for communication with the portable media device, the interface capable of receiving an audio signal to be broadcast by the transmitter using the selected operational frequency, the interface element further operable to direct the state signal to the portable media device whereby the portable media device can display the selected operational frequency in the state signal on the display mechanism of the portable media device.

19. An FM transmitter according to claim 18, wherein:
the state signal includes static image information corresponding to the selected operational state to be displayed by the portable media device.
